(19) United States
(12) Patent Application Publication
(10) Pub. No.: US 2009/0139382 A1
(43) Pub. Date: Jun. 4, 2009

(54) PORTABLE MITER SAW

(76) Inventor: James B. Clack, Saint Petersburg, FL (US)

Correspondence Address: James B. Clack, 105 4th Ave. NE #216, St. Petersburg, FL, 33701, US

(21) Appl. No.: 11/949,790

(22) Filed: Dec. 4, 2007

(51) Int. Cl. B26D 1/14; B26D 7/02

(52) U.S. Cl. 83/471.3; 83/452

(57) ABSTRACT

This relates to a miter saw that is portable and can operate in confined spaces to cut elongated work pieces, such as decorative trim, at an angle. These capabilities are achieved through a construction that is physically reversible, makes use of a cradle to provide stability for the work piece, and may provide a rotatable work brace to support the work piece.

### BACKGROUND

1. Field of Invention

This relates to construction and framing tools, especially to the construction of a portable saw as may be used to make angular cuts in decorative trim such as quarter-round-molding, crown-molding, or baseboard.

2. Prior Art

Typical prior art, a miter saw which is electrically powered, is depicted in FIG. 7, comprising a work surface or platen 104 on which the work piece is placed, a vertical surface or fence 105 against which the work piece is aligned, a saw blade 101 to cut the work piece, a rotating table 152 that can be pivoted at a miter angle, and a pivot 107 for the cutting head 180 that allows the saw blade 101 to be advanced through the work piece in order to cut it. Additionally the saw also comprises a motor 102 to power the saw blade, a saw dust collector 125, a control 181 for adjusting the miter angle, a trigger switch 126 for applying power to the motor 102, and a movable handle 115 for advancing the saw blade 101 into the work piece. Typically such miter saws also have blade guards that shield the operator from the blade, a bevel pivot to tilt the saw blade, reinforcing structures, drive mechanism, various adjustments, locks, bearings, and may even have slides to reposition the saw blade.

In order to better understand miter saws, one must look back in history. Credit for the invention of the miter saw is often attributed to Ed Niehaus in 1964 as well as his improvements U.S. Pat. No. 3,821,918 patented in 1974. Although he formalized the design of most modern miter saws, a design for a powered miter saw was published in Great Britain over one hundred years ago as (GB) 190513646 to John Abraham Peer (1905). That particular invention also claims portability, as does the present invention. Going back much further in time, one discovers a patented method that describes a powered saw for cutting angles in order to make wedge-shaped wheel segments, or fellies, as X7560 to J. Hamilton (1833).

When using a conventional miter saw, it is often placed in a location that is separated from the work area, to where the work piece must be conveyed for each cut. This is because these saws can be cumbersome and the related operation often involves work pieces that must be installed around the walls of various rooms. Such a conventional tool may be several feet away from the work area or possibly rooms away or even on a different floor level, depending upon accessibility.

A conventional miter saw generally has a base that is fairly heavy in order to provide stability. This is because the act of cutting a work piece may involve several simultaneous manual operations, such as holding the work piece, engaging the motor, advancing the saw, and catching the remnant. If such a miter saw is light weight, then one more manual operation is required: that of keeping it stable. The concept of portability is often addressed by scaling down the physical size of the device, or by allowing the cutting head more freedom of movement, or via a collapsible framework, improvements that may not significantly resolve the need to provide stability.

Yet another issue with portability is that of reversing the miter angles. Miter angles are reversed when cutting a work piece that is to mount to a ceiling rather than to a floor. The operator of a conventional miter saw has two choices in solving this problem. The operator may either turn the work piece around to cut from the other side or may cut it on a bevel angle, which a secondary axis of rotation, instead of a miter angle. The former is an inconvenient solution because it can be unwieldy to reverse a long work piece. The latter is not ideal as it requires a bevel angle, often adding to the complexity and weight of the tool.

### SUMMARY OF THE INVENTION

In this document I refer to certain possible embodiments that make use of several of the claims in various constructions. This is not to be construed to be a proposal for any one specific implementation in preference to any other. Some assemblies are also mentioned, although it is not ruled out that an assembly might be constructed of a single unit.

The invention relates to a portable tool that can access the work piece in a confined area with limited accessibility, yet retain a good degree of safety and accuracy. This portable miter saw offers a convenient and practical solution that can be positioned on the work piece at or near the work site. The concept of portability presents numerous problems, many of which are resolved herein.

To address the need for stability, a solution is proposed in the form of operator controls that allow the use of two hands to deal with the cutting task while stabilizing the unit. This can be seen in FIG. 1 wherein the operator's hands 194 grasp the fixed handle 114, engaging the presser feet 108 by pulling the squeeze grip 112, and grasp the movable handle 115, pulling the trigger switch 126 and advancing the cutting head 180 into the cradle 158 with intent to sever the work piece 159.

In order to cut work pieces in which the angle of the cut must be reversed across the axis of the work piece, a solution is proposed whereby the portable miter saw can be turned around instead of reversing the work piece. This is facilitated by a construction of the device in which the operator controls are relocated so that they can be accessed from either side, and by providing access for loading and unloading the work piece regardless of the orientation of the miter saw. The resultant miter saw is somewhat symmetric, and can be turned around on its base in order to reverse the cut.

Another improvement is introduced in the form of a novel orientation for the work piece cradle in order to make the device more useful in a portable configuration. An elongated cradle supports the work piece rather than a rotating table and fence. The cradle 158 may be oriented to form an upright V-shape as seen in FIG. 1 for even more convenience. This provides a more natural area for the work piece to settle into and it avoids the problem of enticing the operator to put his fingers near the saw blade when restraining the work piece.

In order to restrain the work piece in the cradle, presser feet are used, which are clamps to hold the work piece in place. After the saw blade has severed the work piece, they hold down both the finished portion as well as the remnant. Presser feet are urged by a double-acting spring to remain depressed once so oriented, or to remain retracted when lifted from the work piece. Such actions assist the operator in loading and unloading the work piece.

A variety of compact and portable miter saws already exist, but they are substantially based on the design of full size miter saws. In this document I propose a novel and unique construction of a miter saw in order to render it practical in a more portable configuration.

### BRIEF DESCRIPTION OF THE DRAWINGS

The figures that accompany this document are summarized below. These illustrate specific constructions, but should not be interpreted as the only possible embodiment.

FIG. 1 is a perspective view of a preferred embodiment showing the operator's hands in order to illustrate approximate scale.

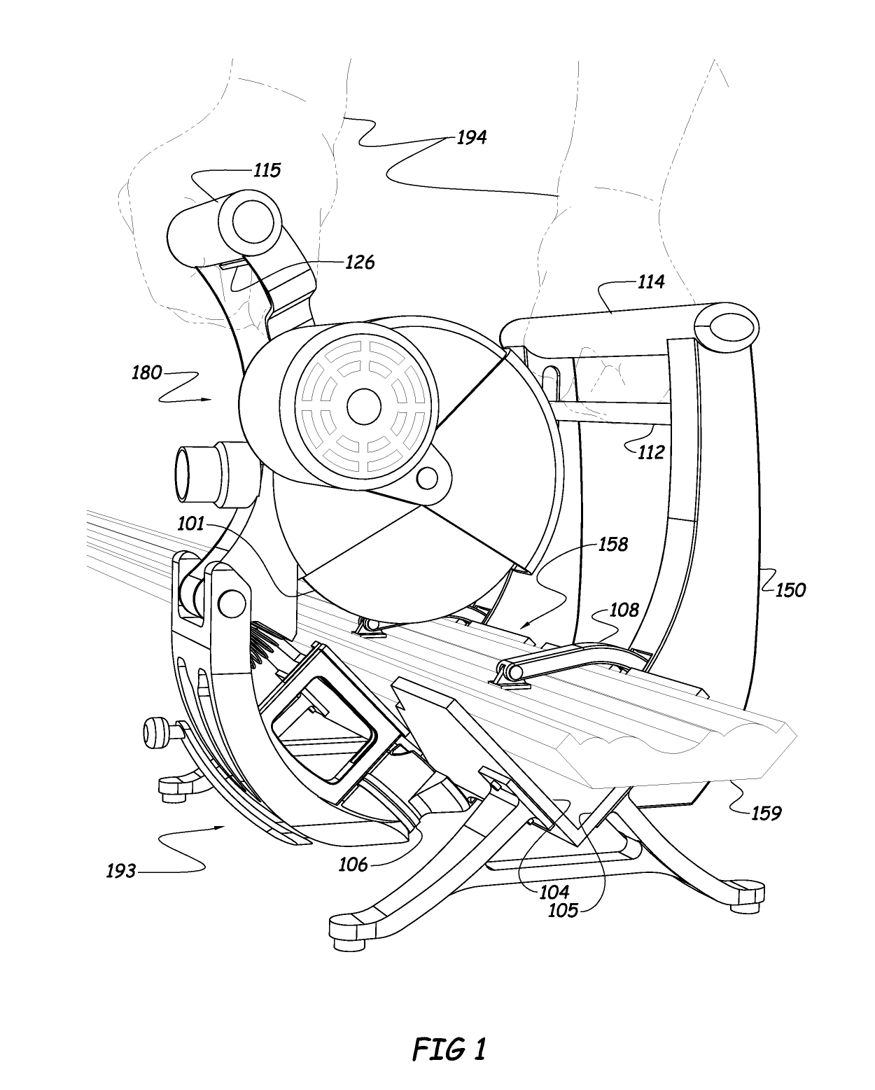

FIG. 2 is a front view of the embodiment of FIG. 1.

FIG. 3 is a front view of the embodiment with the miter support tilted

FIG. 4 is a sectional view as indicated on FIG. 2.

FIG. 5 is a detailed view showing the presser foot in a different position as indicated by the phantom block on FIG. 4.

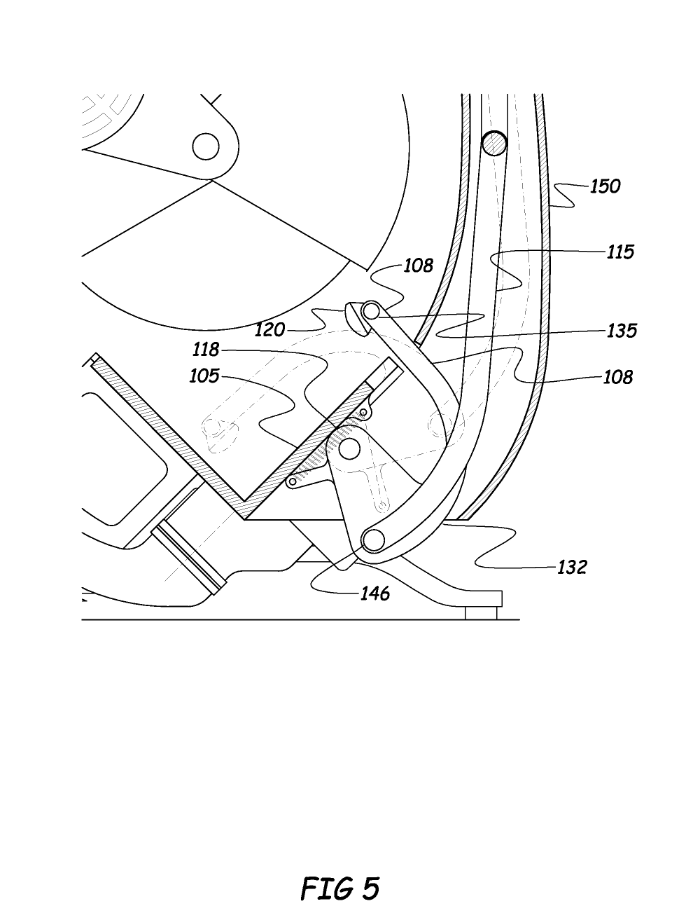

FIG. 6 is the detail view of a section showing the rotatable work brace. Some parts are not shown and the cradle is shown in broken lines in order to improve legibility.

FIG. 7 is an illustration of prior art—a conventional miter saw.

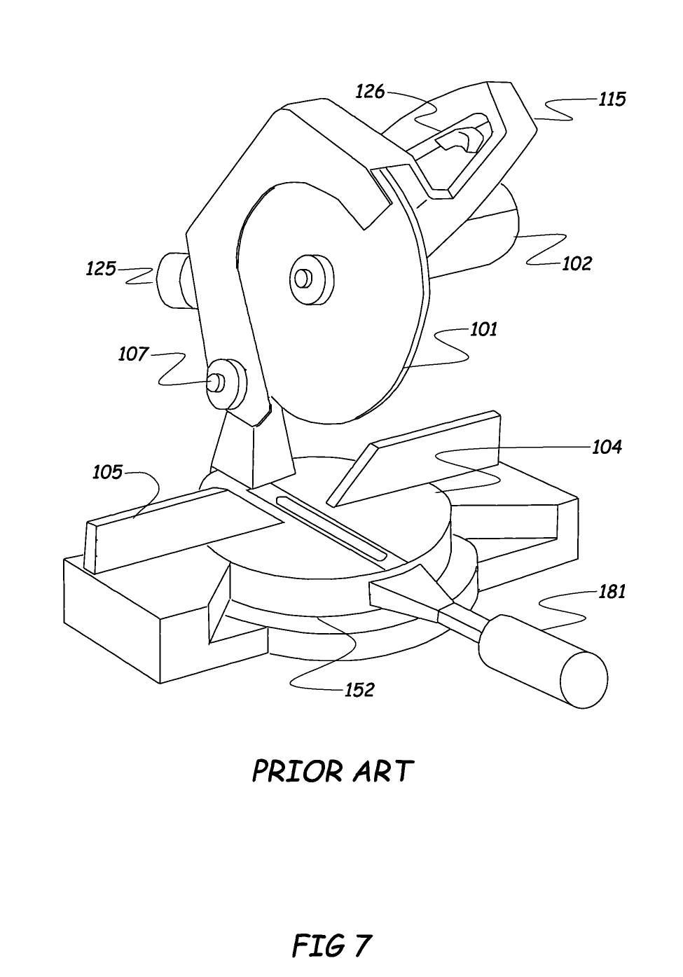

### REFERENCE NUMERALS

The following annotations are used in the text to reference corresponding features on the figures.

101—Saw blade

102—Motor

103—Drive mechanism

104—Platen

105—Fence

106—Miter pivot, about which the miter support 137 pivots

107—Pivot, for arcuate movement of the cutting head 180

108—Presser foot

112—Squeeze grip

113—Linkage, for squeeze grip 112

114—Fixed handle

115—Moveable handle

116—Retractable blade guard

117—Linkage, for retractable blade guard 116

118—Presser foot spring

119—Cutting head spring

120—Toe

122—Clearance area for saw blade

124—Handle, to lock the miter support 137 in place

125—Saw dust collector attachment

126—Trigger switch

132—Crank, disposed on presser foot 108

134—Battery

135—Toe pivot

136—Base

137—Miter support

145—Pivot, axis about which crank 132 rotates

146—Pivot, pivotally links crank 132 to linkage 113

150—Arm

151—Slide

152—Rotating table—prior art only

157—Fixed blade guard

158—Cradle (assembly)

159—The work piece, here shown as a length of crown molding

180—Cutting head (assembly)

181—Control to adjust rotating table 152—prior art only

182—Rotatable work brace

183—Aperture in rotatable work brace

184—Cutting head support

193—Miter assembly

194—Operator's hands, to illustrate approximate scale

Note A—The crown molding 159 is shown as lifted out of the cradle (see text)

### DETAILED DESCRIPTION OF A PREFERRED EMBODIMENT

The following definitions are provided to elucidate some commonly known terms as well as some descriptive verbiage introduced in order to better describe concepts herein.

Work piece—This refers to the item that is to be severed, possibly at an angle. Often this is a length of decorative trim, such as crown molding.

Platen—This refers to a flat surface of the tool against which the work piece rests, often correlating to the floor or ceiling to which the work piece is to be ultimately mounted.

Fence—This refers to a flat surface of the tool against which the work piece rests, often correlating to the wall to which the work piece is to be ultimately mounted.

Cradle—This term refers to the V-shape formed by the platen and the fence. The work piece generally rests in the cradle.

Miter angle—This is an angle, measured relative to the fence, at which the work piece is to be cut.

Bevel angle—This is a secondary angle of rotation, typically about an axis that passes through a diameter of the saw blade. The preferred portable miter saw does not require a bevel angle, although a bevel angle is not precluded from alternative constructions.

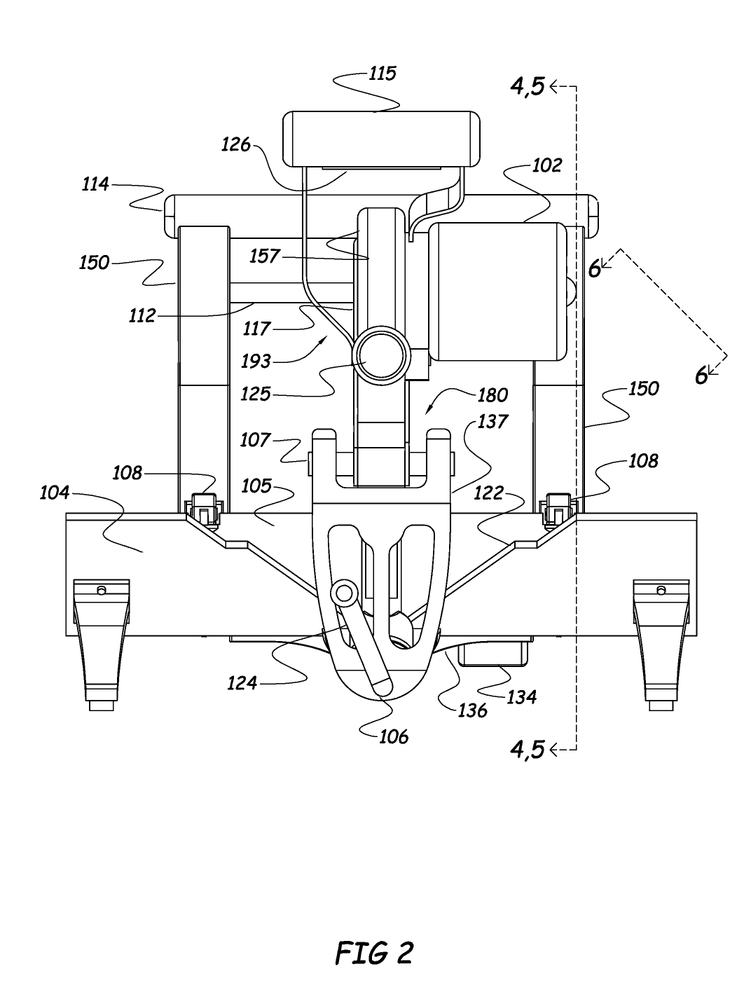

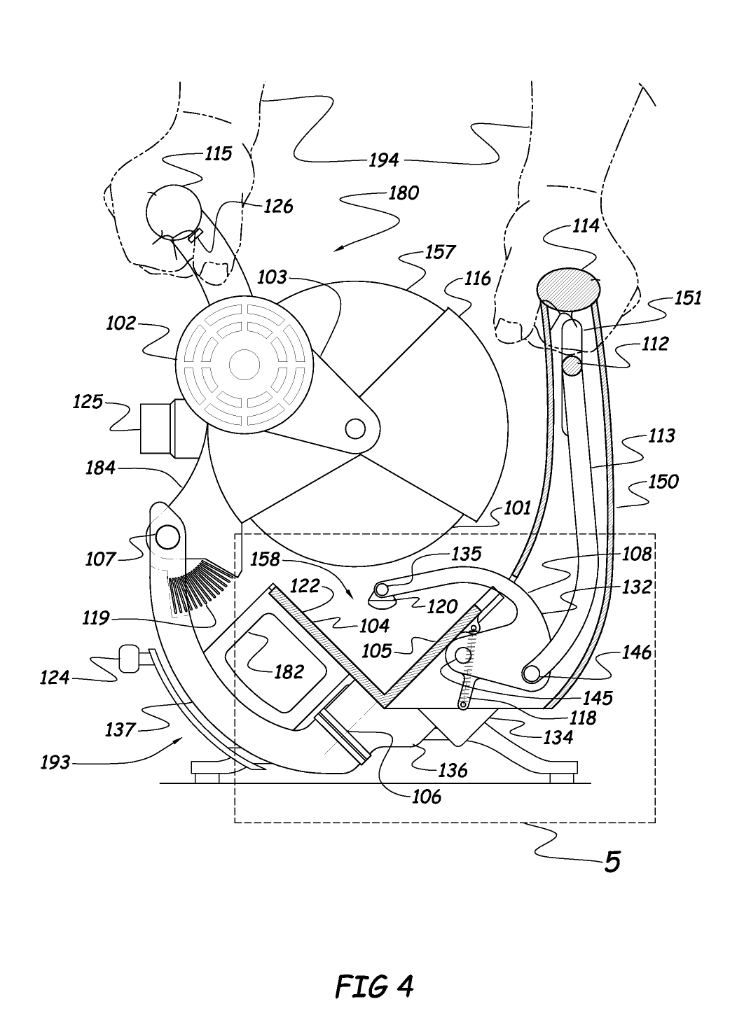

Referring primarily to FIG. 2 and FIG. 4, base 136 supports a cradle 158, which comprises a fence 105 and a platen 104. During the cutting operation, the edge of the work piece 159 that rests against the platen 104 is the edge that often will be ultimately mounted to a floor or ceiling after cutting. The edge of the work piece 159 that rests against the fence 105 is the edge that often will be ultimately mounted to a wall after cutting.

The miter support 137 can be rotated around a miter pivot 106 which has an axis that passes through the plane of the surface of the fence 105 and is at right angles to platen 104. Although depicted at the bottom of the fence 105, the miter support 137 alternatively might be disposed at the top of the fence 105, yet still be pivotally located on the axis of the miter pivot 106. The miter pivot 106 may be further improved via the use of bushings or via ball bearings or roller bearings. Further, an indexer might be used to urge the miter pivot 106 toward commonly used angles.

The miter assembly 193 is comprised of the miter support 137, which is pivotally disposed relative to the base 136 via miter pivot 106 providing rotational movement to cut at a miter angle, and is also pivotally disposed relative to the cutting head 180 via pivot 107.

The miter support 137 may be locked rotationally into position on the miter pivot 106 by tightening handle 124 to prevent the pivot from rotating by engaging a lock on a rotational surface. The tightening handle 124 may be disposed on the miter support 137 or on the base 136 in various constructions. The cutting head 180 can thereby be disposed at a miter angle yet still advance toward the work piece 159 via rotational movement around pivot 107. The cutting head 180 supports a saw blade 101 that can be advanced through the work piece 159 by arcuate movement around the pivot 107. Typically the saw blade 101 is pivotally disposed on the cutting head 180 so that it can spin in order to provide cutting action. In an alternative embodiment the pivot 107 might be replaced by a slide mechanism that provides linear movement rather than arcuate movement.

The cutting head 180 comprises a cutting head support 184 and a saw blade 101 used in cutting operations. The saw blade 101 is powered through a drive mechanism 103 by the motor 102. The drive mechanism 103 transfers power from the motor 102 to the saw blade 101 via a mechanical transmission, which is, minimally, an interconnecting shaft. Although a circular saw blade is depicted, a different construction could make use of a reciprocating linear saw blade instead.

Movement of the cutting head 180 can be achieved by operator pressure on the moveable handle 115 which is disposed on cutting head 180. The cutting head spring 119 urges the cutting head 180 to retract from the work piece. The pivot 107 may be further improved via the use of bearing sleeves or via ball or roller bearings.

When the cutting head 180 is fully retracted, it allows sufficient access for loading the work piece 159 into the cradle 158. When the cutting head 180 is fully advanced, the cutting edge of the saw blade 101 passes into a clearance area 122 in order to fully pass through the work piece 159 with intent to sever it into two portions. This clearance area 122 is deep enough to allow the saw blade 101 to completely sever the work piece 159, and wide enough to do so over the entire rotational range of movement of the cutting head 180 around the miter pivot 106.

Furthermore, on the cutting head 180, the saw blade 101 may be shielded from the operator by a fixed blade guard 157, as well as by a retractable blade guard 116 that in turn is retracted by a linkage 117 when the cutting head 180 is advanced into the work, as is common with existing miter saws.

The motor 102 is supplied with power from a source of power, such as battery 134. That power gets applied to the motor 102 when the operator engages trigger switch 126. For safety purposes, the trigger switch 126 may be improved by the addition of an interlock.

When the saw blade 101 cuts the work piece 159 it causes sawdust to be released, which generally moves in a manner consistent with the rotation of the saw blade 101. The portion of the fixed blade guard 157 that lies in that impending direction serves to collect the saw dust, where it can be extracted by suction or collected in a porous sack applied to the saw dust collector 125 opening. The use of suction or of the porous sack is common with existing miter saws.

The following description of the work piece clamping mechanism can be best seen in FIG. 2 and FIG. 4.

The work piece 159 is held in place during the cutting operation by two presser feet 108 which are disposed on crank 132, which rotates around a pivot 145. The presser feet are urged away for their rotational center position by the presser foot spring 118, which is situated such that it's center of force lies on one side of the pivot 145 when the presser feet are retracted, and on the other side of the pivot 145 when they are depressed. Such geometry is common in power tools and serves to keep the presser feet 108 retracted once moved to a retracted position as well as served to keep the presser feet engaged once so-positioned. Alternatively, the spring action may be omitted or limited to urging the presser feet in a single direction.

On the end of each presser foot 108 is a toe 120 attached to it via a pivot 135. The toe contacts the work piece 159 to apply pressure to it when the presser foot 108 is engaged, and the pivot 135 allows the toe to sit squarely against a surface of the work piece 159. In alternate constructions the toe 120 may be rigidly disposed on the presser foot 108 and make use of a flexible pad to restrain the work piece 159.

A crank 132 is attached to a linkage 113 via pivot 146 which rotates the crank 132 when the linkage 113 is moved along its longitude. The other end of the linkage 113 is disposed on the movable squeeze grip 112. One such linkage 113 and crank 132 interconnects each end of the squeeze grip 112 to each presser foot 108, although typically they share a single axle of pivot 145. The movable squeeze grip 112 can travel along the slides 151, which are located in the arms 150 near the fixed handle 114, so that the operator can easily hold onto the fixed handle 114 while pulling the movable squeeze grip 112 with one hand, which in turn, will move the linkage 113 along its length. That force is then transferred to the crank 132 and will thereby depress the presser foot 108 in order to restrain the work piece 159 via pressure upon it by the toe 120. The fixed handle 114 is disposed on the base 136 by two arms 150, which may also conceal the linkages 113 inside. Other constructions of this linkage that engages the presser foot 108 are also possible, such as the use of a squeeze grip that pivots or a single linkage in order to allow the use of only one arm 150.

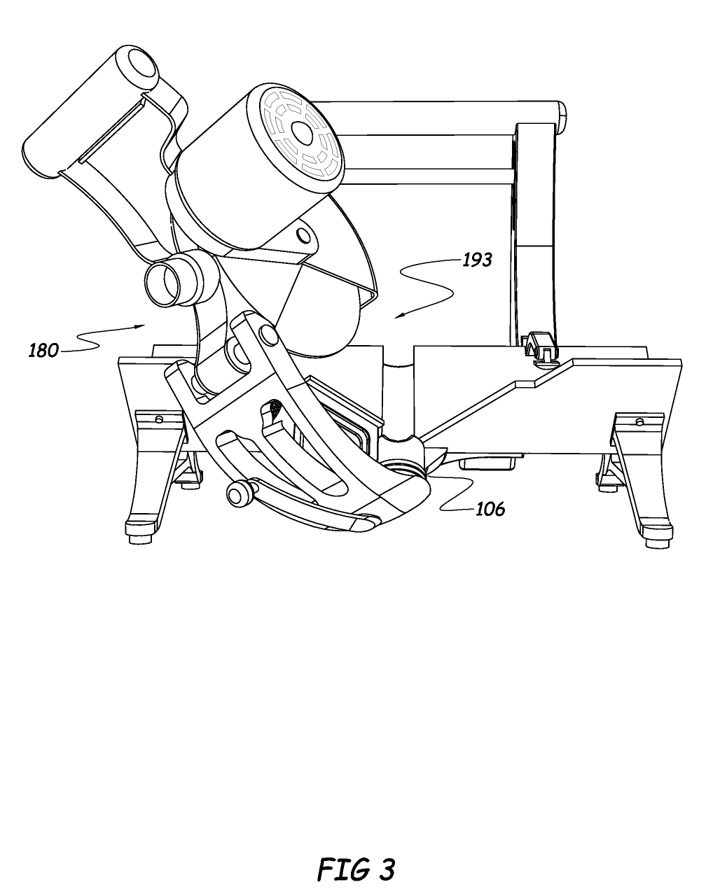

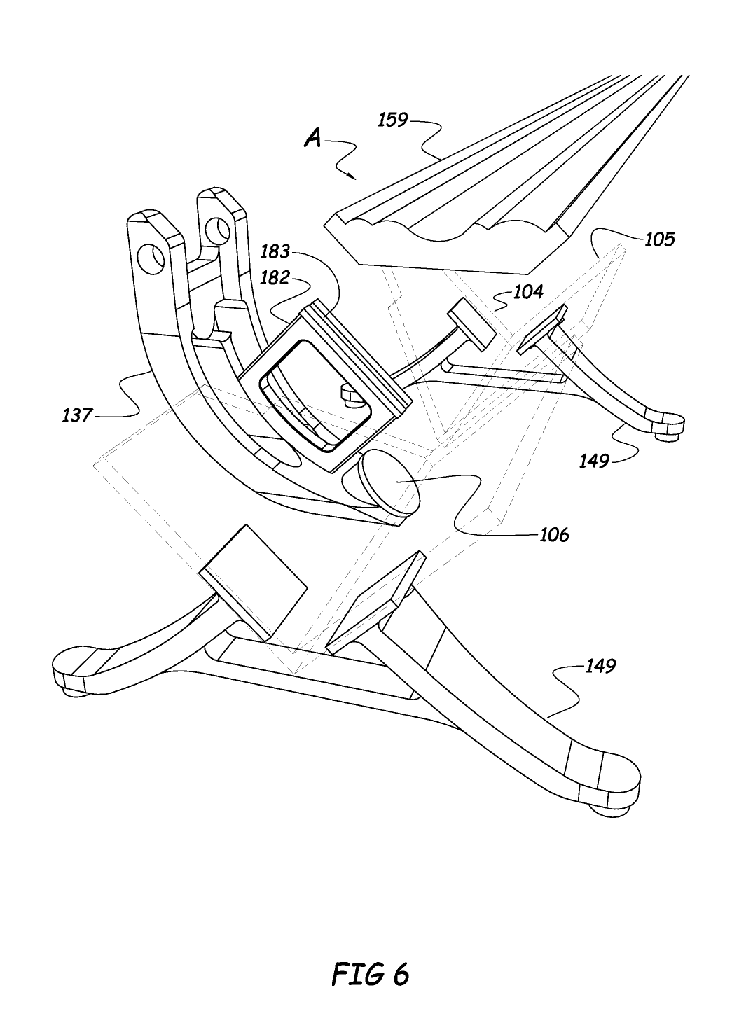

Refer to FIG. 3 and FIG. 4 for the identification of the miter support 137 and related parts. An improvement thereto will also be described, and is illustrated in FIG. 6. In this figure, as per Note A, the work piece 159 is shown as lifted out of position, raised above the cradle 158 in which it normally rests, so that the rotatable work brace 182 is fully visible.

In order to better support the work piece 159 when it is being cut, a rotatable work brace 182 is used. It provides a support surface that is in the same plane as the platen 104, but rotates to align with the saw blade 101. This is implemented through a rotatable work brace 182 that is disposed on miter support 137. Disposed on the rotatable work brace 182 is an aperture 183 that serves the purpose of providing clearance for the cutting edge of the saw blade 101 to pass through and sever the work piece 159.

The rotatable work brace 182, like the miter support 137, is pivotally disposed on miter pivot 106 so that they rotate together around the same axis. The miter pivot 106 allows the miter support 137 and the rotatable work brace 182 to rotate together relative to the base 136.

### Operation of Preferred Embodiment

Operation of the preferred embodiment consists of several steps. Here, the work piece 159 is a length of crown molding that is to be cut at an angle to fit at the joint between a wall and ceiling.

1. Since the ultimate mounting, in this example, will be at a joint between the wall and ceiling, the operator will orient the portable miter saw so that the platen 104 is nearer to the wall than the fence 105. If the molding were instead to be located at the joint of the wall and floor, then the operator would orient the portable miter saw so that the fence 105 was nearer to the wall than the platen 104.

2. Typically the operator will preset the miter angle to half of the included angle, which is the angle between two walls where the angled end of the crown-molding it to be ultimately located. Most often the included angle is 90 degrees, resulting in a miter angle of 45 degrees. This is a preset operation and is done by rotating the miter support 137 into position and then locking the handle 124.

3. The portable miter saw will initially be stabilized with one hand on the fixed handle 114, and the presser feet 108 will be released with that same hand by pressing the squeeze grip 112 away from the fixed handle 114. Using the other hand, the operator will place the work piece 159 in the cradle and then, with the initial hand, will pull the squeeze grip 112 to engage the presser feet 108, allowing them to urge the work piece 159 into the cradle 158.

4. The operator will place the second hand on the movable handle 115 and pull the trigger switch 126 to engage the motor 102 and start the saw blade 101 spinning. With that same hand, the operator will advance the movable handle 115 to advance the blade into the work piece 159 until it has severed it into two segments.

5. The operator then will release the trigger switch 126, raise the movable handle 115, and wait for the saw blade 101 to stop spinning. He will then push down squeeze grip 112 so that the presser feet 108 are released. He can then remove the work piece 159 and its remnant from the cradle.

6. To cut the other end of the work piece 159, the operator will simply move the power tool to the other end, and resume from step 1 above, where he will tilt the miter support 137 to the other side if necessary.

I claim:

1. A miter saw, comprising:
a. a cradle comprising two flat surfaces, the fence and the platen, on which to place a work piece,
b. a miter support, which is a brace that pivots around a miter axis that is perpendicular to the platen surface of said cradle,
c. a powered saw blade,
d. a cutting head comprising said saw blade and a support for said saw blade which allows cutting motion of said saw blade,
e. an attachment pivotally adjoining said miter support to said cutting head to allowing movement of said cutting head and said saw blade deeper into said cradle, in order to sever the work piece,
f. a rotatable work brace disposed on said miter support with a flat surface in the same plane as the platen,
whereby said miter saw provides support to the work piece on said fence, said platen, and said flat surface of the rotatable work brace.

2. A miter saw, comprising:
a. a cradle, oriented as an upright vee, with two flat surfaces perpendicular to one another, the fence and the platen, on which to place a work piece, and with clearance areas to allow the partial passage of a saw blade,
b. a miter support, comprising a brace pivotally disposed around a miter axis that is perpendicular to the platen surface of said cradle,
c. a powered saw blade,
d. a cutting head comprising said saw blade and a support for said saw blade which allows cutting motion of said saw blade,
e. an attachment pivotally adjoining said miter support to said cutting head and allowing movement of said cutting head and said saw blade deeper into said cradle.

3. The miter saw of claim 2 further comprising a clamping mechanism for the work piece, comprising:
a. at least one clamp for restraining said work piece,
b. an operator control to engage said clamp, where said operator control is not in the immediate vicinity of any exposed part of said saw blade,
c. a linkage for transferring the force applied to said operator clamp-control to said clamp.

4. The miter saw of claim 2 further comprising a rotatable work brace, comprising:
a. a brace which is disposed on said miter support,
b. a surface on said brace that is in the same plane as the platen of said cradle, on which said work piece may rest,
c. a clearance area to allow the partial passage of the saw blade as it passes through said surface on said brace.

5. A miter saw, comprising:
a. a supporting base with at least one operator handle located near the top of the miter saw for the operator to grasp from either the front or the back,
b. a cradle comprising two flat surfaces, the fence and the platen, on which to place the work piece, and with clearance areas to allow the partial passage of a circular saw blade,
c. a miter support, comprising a brace pivotally disposed around a miter axis that is perpendicular to the platen surface of said cradle,
d. a circular saw blade,
e. a cutting head comprising said saw blade and a support for said saw blade which allows said circular saw blade to spin around its axis,
f. a pivot that joins said miter support to said cutting head and allows movement of said cutting head and circular saw blade deeper into said cradle,
g. an electric motor,
h. a source of electric power for said motor,
i. a switch, which can permit or interrupt the application of electricity from said source of power to said motor,
j. a drive mechanism applying the force of said electric motor to said circular saw blade, which minimally is an interconnecting shaft,
k. a guard to shield the operator from said circular saw blade,
whereby said miter saw can be turned around and used from the other side in lieu of turning the work piece around end-for-end.

6. The miter saw of claim 5 further comprising a clamping mechanism for the work piece, comprising:
a. at least one clamp for restraining said work piece,
b. an operator control to engage said clamp, where said operator control is not in the immediate vicinity of any exposed part of said saw blade,
c. a linkage for transferring the force applied to said operator clamp-control to said clamp,
whereby the operator can engage said clamps without placing his hands near an exposed portion of said circular saw blade.

7. The miter saw of claim 6 wherein said clamping mechanism is spring-loaded with a double-action so that said clamp remains retracted when open, and provides pressure to restrain said work piece in position when closed.

8. The miter saw of claim 5 further including a rotatable work brace, comprising:
a. a brace which disposed on said miter support,
b. a surface on said brace that is in the same plane as the platen of said cradle,
c. a clearance area to allow the partial passage of a circular saw blade as it passes through said plane,
whereby said rotatable work brace provides additional support for the work piece as it is being severed.

9. The miter saw of claim 5 wherein said operator handle located near the top of the miter saw is offset to one side, and another handle is disposed on said cutting head near the top of the miter saw and offset toward the other side, whereby the operator can grasp the two handles in order to provide stability while maintaining control over the cutting operation.
